(19) United States
(12) Patent Application Publication
(10) Pub. No.: US 2026/0202316 A1
(43) Pub. Date: Jul. 16, 2026

(54) ASSEMBLY AND METHOD FOR DETECTING AND/OR DETERMINING THE CONCENTRATION OF ONE OR MORE SUBSTANCES IN A LIQUID OR GASEOUS MEDIUM

(71) Applicant: Fraunhofer-Gesellschaft zur Förderung der angewandten Forschung e.V., München (DE)

(72) Inventors: Thorsten GRAUNKE, Erlangen (DE); Wladimir TSCHEKALINSKIJ, Nürnberg (DE); Sebastian HETTENKOFER, Erlangen (DE); Stephan JUNGER, Erlangen (DE); Jens-Uwe GARBAS, Erlangen (DE); Ruslan RYBALKO, Erlangen (DE)

(73) Assignee: Fraunhofer-Gesellschaft zur Förderung der angewandten Forschung e.V., München (DE)

(21) Appl. No.: 19/135,829

(22) PCT Filed: Dec. 1, 2023
(86) PCT No.: PCT/EP2023/083944

§ 371 Date: Jun. 5, 2025

(30) Foreign Application Priority Data
Dec. 8, 2022 (DE) 10 2022 132 669.1

(51) Int. Cl. G01N 21/17

(52) U.S. Cl. CPC G01N 21/1702; G01N 2021/1704; G01N 2201/0636

(57) ABSTRACT

An assembly for detecting and/or determining the concentration of one or more substances in a liquid or gaseous medium comprises a plurality of distributed measurement cells having one or more detectors, so that an absorption of optical radiation in the liquid or gaseous medium can be sensed in the measurement cell for a plurality of characteristic absorption peaks of the substances to be determined, and an optical device for producing and guiding the optical radiation, so that a beam of the optical radiation is guided through all the measurement cells, and which optical device comprises a plurality of light sources, which each emit radiation at a wavelength of a different one of the characteristic absorption peaks, and a beam combiner, by means of which the radiation emitted by the light sources is merged to form the beam. The assembly allows spatially resolved measurement and can be implemented economically.

### TECHNICAL FIELD

The present invention relates to an assembly for detecting and/or determining the concentration of one or more substances in a liquid or gaseous medium which exhibit characteristic absorption peaks when illuminated with optical radiation. The invention also relates to a method for detecting and/or determining the concentration of one or more substances using such an assembly.

The analysis of liquid or gaseous media with regard to the concentration of individual substances in said media plays an important part in many technical and scientific applications. Thus, many substances have characteristic optical absorption peaks that form a fingerprint of the respective substance, so that the substances can be identified or determined uniquely using optical absorption spectroscopy, for example. Photoacoustic spectroscopy can also be used to determine the concentration of substances in a liquid or gaseous medium. In photoacoustic spectroscopy, the specific absorption of light at an absorption peak creates a pressure change or acoustic wave in the medium, which is captured with a detector and converted into an electrical signal. A microphone may be used as the detector, for example. The captured pressure change is a measure of the concentration of the corresponding material. However, the wavelength of the incident optical radiation must be adjusted to the material or materials to be measured for each measurement. The required wavelength can be adjusted with the aid of a spectral filter, for example, or by using a tunable laser.

### PRIOR ART

For example, EP 3508836 B1 discloses a photoacoustic gas sensor in which radiation from a broadband IR light source is passed through a bandpass filter into a measuring chamber containing the gas that is to be measured. The optical bandpass filter only allows a certain part of the light spectrum to pass. The central wavelength is adjusted to the absorption maximum of the gas to be detected. Through temporal modulation of the IR light source up to 100 Hz, the absorption of the radiation in the gas creates a sound wave within the measuring chamber; the sound wave is measured by a highly sensitive pressure sensor on the measuring chamber and is a measure of the concentration of the absorbing gas. However, the gas sensor in this assembly can only detect a gas with an absorption maximum at the corresponding filter wavelength.

DE 102021108745 A1 discloses an assembly for multispectral light emission and a multispectral sensor equipped therewith, which enable simple, fast adjustment or change of the emitted wavelengths. This assembly has a broadband light source merged with a filter array of multiple spectral filters and a switching device for controlling the passage of the light emitted by the light source through individual filters of said filter array. This enables the wavelength or spectral distribution of the emitted optical radiation to be adapted or varied depending on the number and characteristics of the various filters in the filter array. This in turn means that the spectral distribution of the emitted light can be adapted for the respective application, for example also to characteristic absorption peaks in optical absorption spectroscopy or photoacoustic spectroscopy for determining the concentration of substances in a medium. The assembly includes one or more broadband light sources, a filter array, a switching device and a common detector.

Especially for the selective analysis of complex samples in the sub-ppb range, many substances in a liquid or gaseous medium must be determined with high sensitivity in terms of their concentration. This should be done as economically as possible. Moreover, in many applications it is desirable to carry out a spatially resolved measurement to detect and/or determine the concentration of certain substances. This may be necessary, for example, in order to identify the location of disturbances in an industrial environment, for example to detect a leak, a fire or an undesirable odour.

The object of the present invention is to provide an assembly and a method for detecting and/or determining the concentration of one or more substances in a liquid or gaseous medium, which can be implemented economically and enable spatially resolved measurement.

### PRESENTATION OF THE INVENTION

The object is solved with the assembly and the method according to claims 1 and 12. Advantageous variants of the assembly and the method are the subject matter of the dependent claims or may be discerned from the following description and the embodiments.

The suggested assembly is designed for detecting and/or determining the concentration of one or more substances, particularly pure substances, in a liquid or gaseous medium, which have characteristic absorption peaks when illuminated with optical radiation. The assembly comprises a plurality of measurement cells distributed in the liquid or gaseous medium, each of which has one or more detectors, with which an absorption of optical radiation in the liquid or gaseous medium in the measurement cell can be detected for several of the characteristic absorption peaks of the substances to be detected or whose concentration is to be determined. The measurement cell has at least one inlet for the liquid or gaseous medium, for example a diffusion opening, and at least one inlet and one outlet window for the optical radiation. For this purpose, the measurement cells may have a housing that is completely transparent to the optical radiation. The assembly further comprises an optical device for generating and guiding the optical radiation. For this purpose, the device has a plurality of light sources, each of which emits radiation, preferably narrow-band radiation, at the wavelength of a different one of the characteristic absorption peaks of the one or more substances to be detected and is designed such that it guides a beam of optical radiation through all the measurement cells of the assembly. The beam preferably passes through the individual measurement cells one after the other. The optical device also has a beam combiner, via which the radiation emitted by the light sources is merged to form the beam.

With the combination of beam combiner and several light sources adjusted to the characteristic absorption peaks, the assembly can be implemented more economically, and a larger spectral range can be covered than by using a tunable light source, for example. In such case, a dedicated light source is preferably provided for each of the characteristic absorption peaks to be recorded. The number of light sources used in the suggested assembly and the associated method is preferably at least equal to the number of a selection of the characteristic absorption peaks that is required at minimum for a determination of the concentration of one or more substances in the liquid or gaseous medium. In this context, the fact that in many cases not all of the characteristic absorption peaks of this substance have to be measured in order to uniquely identify and determine the concentration of this substance, but rather the measurement of a smaller number of absorption peaks, i.e. a selection from the characteristic absorption peaks is sufficient, is used to advantage.

A narrow-band light source is understood to mean that the bandwidth of the radiation emitted by the light source is small enough to detect only one of the characteristic absorption peaks of the substance or substances to be detected in the liquid or gaseous medium. The bandwidth of the emitted radiation of the respective light source is preferably <500 nm, particularly preferably <200 nm. Each light source is preferably designed to detect the absorption at a different characteristic absorption peak of the selection made.

In order to form the beam of optical radiation from the light emission from the individual light sources, the optical device has a beam combiner, via which the radiation emitted by the light sources is merged or formed into the beam. This beam combiner may be, for example, an optical WDM module (WDM: Wavelength Division Multiplexing) or an optical fibre coupler (fibre combiner).

In the present patent application, the light source is understood to mean a light-emitting unit which emits preferably narrow-band radiation optical at the corresponding wavelength. This may be a single light emitter, for example a laser diode or a light emitting diode (LED) which emits the preferably narrow-band radiation directly. However, the light source may also be formed by a broadband emitting light emitter with one or more upstream spectral filters, wherein the filter or filters then have the corresponding, preferably narrow-band, passband at the desired wavelength. Additional optical elements, for example lenses or optical fibres, may also be components of the light source.

Because of its suggested design, the assembly may easily be adapted to the respective measuring task, i.e. it can be designed specifically for the substances to be determined in the liquid or gaseous medium by selecting the required number and emission wavelength of the light sources in each case.

The distributed arrangement of the individual measurement cells, which are preferably spaced apart from one another and therefore do not border one another, enables spatially resolved measurements to be made even in a larger room, such as a hall. The individual measurement cells share the light sources. A measurement at different absorption peaks can be carried out, for example, by time-shifted control of the individual light sources assigned to the different absorption peaks. The assembly can be created cost-effectively through this simple structure and enables the measurement of more complex mixtures of substances by virtue of the number of light sources of different wavelengths.

In the suggested assembly, each light source is preferably designed for a specific wavelength. One or more detectors with different measuring principles can be used per measurement cell. The technique of photoacoustic spectroscopy (PAS) is particularly preferred for capturing the absorption. Of course it is also possible to use a combination, for example of optical absorption spectroscopy and photoacoustic spectroscopy, or even just optical absorption spectroscopy. In principle, different types of detectors can be used in the measurement cells, for example microbolometers, pyroelectric detectors, resistive detectors (MOX), thermal conductivity detectors (TCD), heat tone detectors, photodetectors or pressure detectors and microphones.

The spatial arrangement of the individual measurement cells depends on the respective application and any desired spatial resolution. Preferably, a plurality of measurement cells are arranged on a straight line or path so that they can be irradiated by the beam one after the other without deflection. In a three-dimensional arrangement of the measurement cells, one or more mirrors are preferably used to deflect the beam.

When using the preferred technique of photoacoustic spectroscopy in the measurement cells, the microphones usually used may also be replaced with simple, optically reflective membranes. In order to detect a pressure wave in the measurement cell, in one variant of the suggested assembly the membrane is then illuminated by a measuring beam and the measuring beam reflected from the membrane is preferably returned along the same beam path. The measuring beam may be routed parallel to the beam and is preferably also generated and guided by the device for generating and guiding the optical radiation. A detector for the reflected measuring beam to detect the membrane movement is then also arranged in this device. This embodiment has the advantage that the measurement cells do not require any power and can therefore be designed and arranged without an additional power source or power supply.

Another possible variation of the configuration of the individual measurement cells without cable feeds or integrated power sources is to use a contactless power transmission to the individual measurement cells. To do this, an additional optical beam is guided to each measurement cell and directed at a photodiode in the measurement cell, which then generates the current from the absorbed radiation to operate one or more detectors in the measurement cell. Another electrical component that generates current from the absorbed radiation may also be used instead of a photodiode.

One or more measurement cells may also be designed in such a way that they filter the liquid or gaseous medium at the inlet into the measurement cell, so that only certain substances diffuse into the respective measurement cell. This allows a pre-separation of the substances that are to be detected or determined by the measurement cell.

In the suggested method, the assembly is designed such that the number and emission wavelengths of the light sources are matched to the selection of absorption peaks of the substances that are to be detected or whose concentration is to be measured. The number of measurement cells is selected and they are arranged spatially in such a way that a desired spatial resolution is achieved if required. The individual measurement cells are then used to measure the absorption at the corresponding wavelength or the respective characteristic absorption peak in order to derive the presence and/or concentration of the corresponding substances. The individual light sources are preferably operated in such a way that only at least one light source emitting optical radiation for measurement at one of the characteristic absorption peaks is switched on at any one time.

The suggested assembly and the associated method can be used in many application areas, for example in medicine, the environmental sector, process engineering and civil security. This includes, for example, the analysis of industrial processes and parameters (process monitoring), quality assurance, early fire detection, aroma analysis, detection of off-odours, respiratory gas analysis, security applications, environmental analysis, and use as an electronic nose or electronic tongue. Of course this is not an exhaustive list.

### BRIEF DESCRIPTION OF THE DRAWING

The suggested assembly and the associated method will be explained again below with reference to exemplary embodiments in conjunction with the drawing. In the drawing:

FIG. 1 shows an example of characteristic absorption peaks of EtOH and ethyl acetate;

FIG. 2 shows an example of characteristic absorption peaks of CO and CO₂;

FIG. 3 shows a first example of a variant of the suggested assembly;

FIG. 4 shows a second example of a variant of the suggested assembly;

FIG. 5 shows a third example of a variant of the suggested assembly;

FIG. 6 shows an example of a beam combiner such as may be used in the present assembly;

FIG. 7 shows another example of a beam combiner such as may be used in the suggested assembly; and

FIG. 8 shows another example of a variant of the suggested assembly.

### WAYS TO IMPLEMENT THE INVENTION

The suggested assembly for determining individual substances in a liquid or gaseous medium relies on the fact that the individual substances have one or more characteristic optical absorption peaks (“fingerprints”) via which they can be identified uniquely and via which their concentration in a medium can be determined. On this point, FIG. 1 shows an example of characteristic absorption peaks of EtOH (ethanol) and ethyl acetate. The left-hand part of the figure shows the characteristic absorption peaks of ethanol, and the right-hand part shows the characteristic absorption peaks of ethyl acetate. In order to distinguish between these two substances, it is sufficient to take a measurement at three different wavelengths, namely at 3.4 μm, 8 μm and 9.4 μm.

With the suggested assembly, the concentrations of these two substances in a liquid or gaseous medium can therefore be detected and determined using three narrow-band light sources with central wavelengths of 3.4 μm, 8 μm and 9.4 μm. The concentrations of the two substances can then be determined using the absorption intensity captured by the detector of the respective measurement cell and the ratio of this absorption intensity at the three wavelengths. The suggested assembly and the associated method assume that the individual characteristic absorption peaks of the substances to be detected or determined are known.

FIG. 2 shows another example of characteristic absorption peaks of CO (carbon monoxide) and CO₂ (carbon dioxide). As may be seen from the left-hand part of the figure, CO has a characteristic absorption peak at a wavelength of 4.5 μm. From the right-hand part of the figure it is evident that CO₂ has a characteristic absorption peak at a wavelength of 4.2 μm. To between distinguish and determine the concentration of these two substances, it is therefore sufficient to take a measurement at two wavelengths (4.5 μm and 4.2 μm). To this end, the suggested assembly in its simplest form has only two light sources for these two wavelengths.

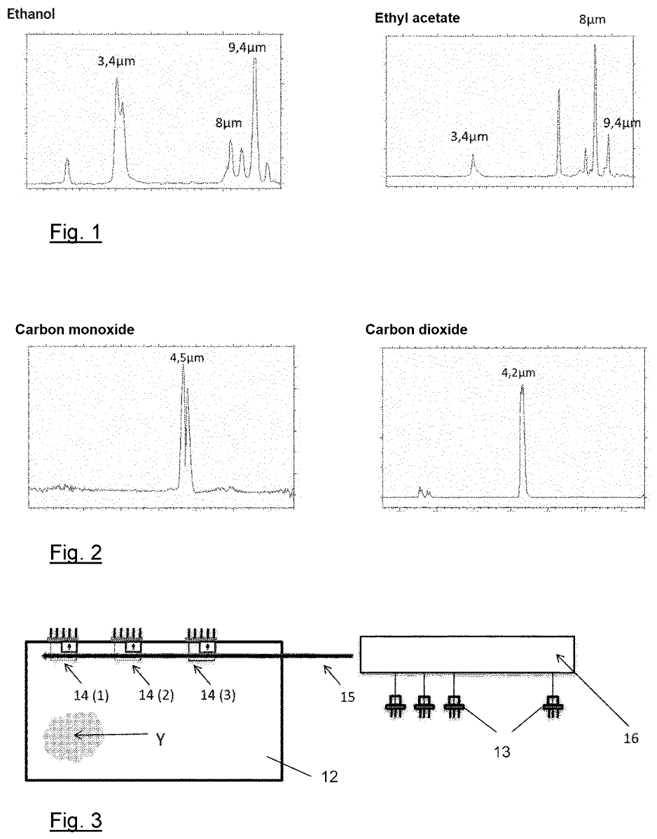

FIG. 3 shows an example of a possible variant of the suggested assembly. In this example, the concentration of substances is to be detected and/or measured at different locations in a room 12. The objective is to obtain spatially resolved measurement to identify the location of disturbances (e.g. due to a leak, a fire, or even a certain smell). In this example, three measurement cells 14(1), 14(2) and 14(3) are arranged in the upper region of the room 12. The measurement cells each have a detector by means of which absorption of optical radiation by the medium in the room 12 and in the measurement cells 14 can be detected. In this example as well as in the following examples, the technique of photoacoustic spectroscopy is used for this purpose. In this example, the measurement cells 14 therefore have microphones that can detect pressure waves such as those caused by absorption of radiation at characteristic absorption peaks. The measurement cells are each designed identically but in principle they may also be different.

To capture the absorption, the assembly includes several narrow-band light sources 13, each of which emits at one of the wavelengths of the characteristic absorption peaks of the substances to be detected and/or measured. The light from the individual light sources 13 is bundled by the beam combiner 16 into a single beam 15, which is directed via one or more optical fibres or a free space into the room 12 and through the individual measurement cells 14, as is indicated diagrammatically in the figure. For example, if a substance leak occurs at location Y, the highest concentration of the escaping substance is measured by the measurement cell closest to the leak Y. Laser diodes or LEDs, or also broadband light sources with one or more upstream optical filter(s), for example, may be used as light sources 13.

In the exemplary embodiment of FIG. 3, a linear assembly of three measurement cells 14 on a straight line was chosen. Of course, the number of measurement cells is freely selectable depending on the application. This also applies to the arrangement of the measurement cells.

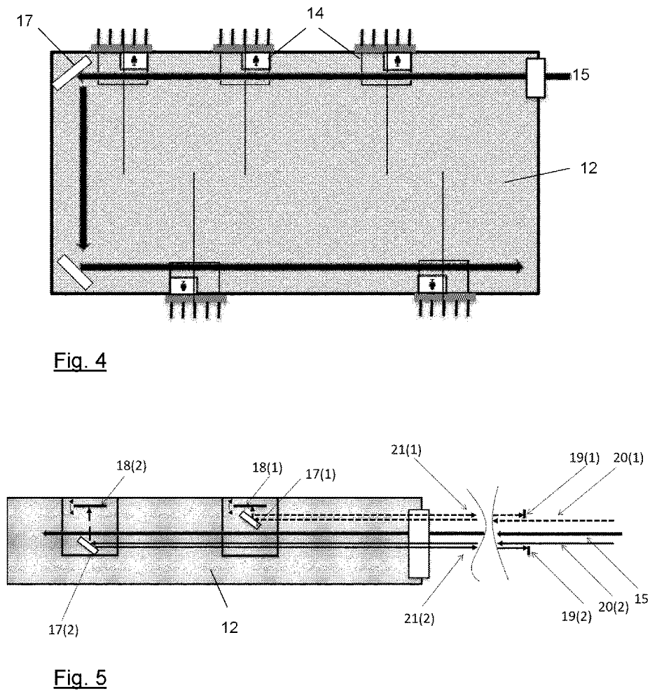

FIG. 4 shows an example of an arrangement of the measurement cells 14 in a room 12 for two-dimensional, spatially resolved measurement and/or localisation of disturbances. The beam 15 is again guided through the individual measurement cells 14 one after the other. The necessary deflection is assured by means of mirrors 17, as is indicated in the figure. The measurement cells 14 in this as well as in the other examples are each transparent for the optical radiation of the beam 15. Alternatively, the housing of the respective measurement cell may also have delimited optical windows at the entry and exit points of the beam 15. Since the absorption of the medium is usually very low for the optical radiation used, even at high substance concentrations, the beam 15 is barely attenuated as it passes through the measurement cells 14.

In some applications it may be advantageous if the individual measurement cells are passive, i.e. do not require any power. FIG. 5 shows a possible variant of the suggested assembly in which the measurement cells 14 do not require their own power supply. Here again, the PAS principle is used for detection. The specific light absorption in the measurement cells 14 creates a pressure change or acoustic wave in the cell. The pressure change is concentration-dependent and can be converted into an electrical signal using a microphone, for example. The substance concentration is then calculated using signal processing/electronics means. In the passive solution suggested in this example, a reflective membrane 18 which does not require any power is used in the measurement cell 14 instead of the electrical microphone. The absorption of the beam 15 creates an acoustic wave in the measurement cell 14, which causes the membrane 18 to vibrate. The oscillation amplitude of the membrane 18 is read out via a collimated optical beam 20/21. This beam 20 is preferably directed into the respective measurement cell 14 parallel to the beam 15, a separate beam 20 being provided for each measurement cell 14. In the measurement cell 14, this beam 20 is then directed onto the membrane 18 and the beam 21 reflected from the membrane 18 is returned along the same beam path and detected in a detector unit 19 with a sensor which converts the oscillation amplitude of the reflected light into an electrical signal. This sensor may be, for example, a line sensor (direct recording of the oscillation amplitude) or an interference sensor. The detection unit 19 is preferably arranged in or on the beam combiner 16.

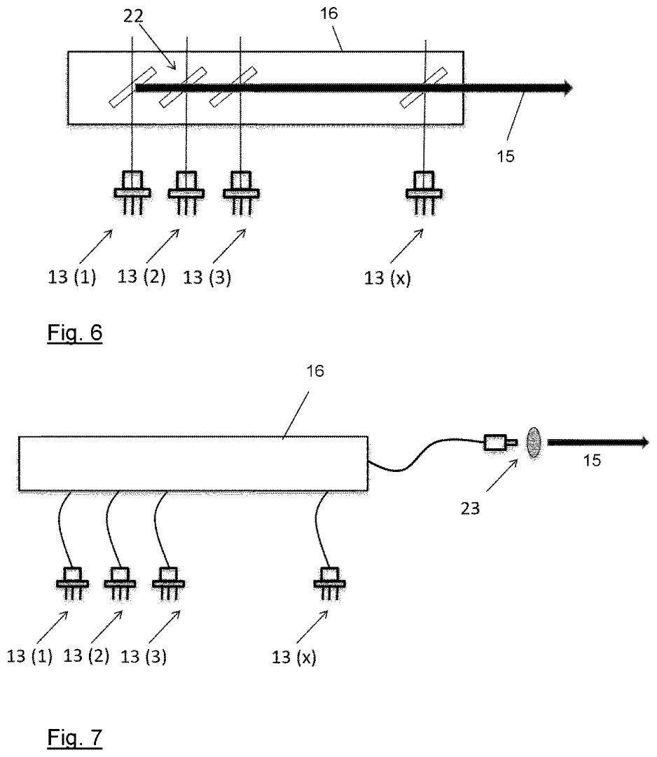

An example of a variant of the beam combiner 16 used in the suggested assembly is represented in FIG. 6. This beam combiner is embodied as an optical WDM module and combines the different wavelengths of the individual light sources 13 with the aid of dichroic mirrors 22 to form a common beam 15.

Another embodiment of such a beam combiner 16 is represented in FIG. 7. In this example, an optical fibre coupler consisting of a known coupler, for example a fusion coupler, functions as the beam combiner. The radiation from the individual light sources 13 is guided into the fibre coupler through fibres, as suggested in the figure. An optical system 23 is present at the output of the fibre coupler to collimate the emerging beam.

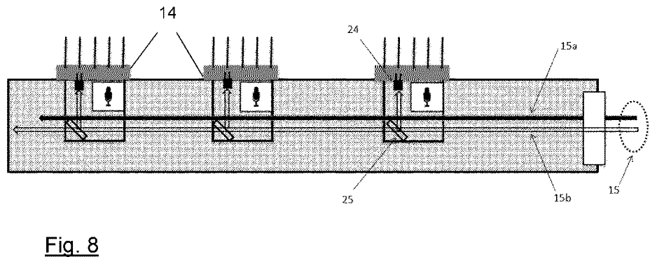

Finally, FIG. 8 shows yet another example of a variant of the suggested assembly, in which the individual measurement cells 14 do not require their own power supply. In this example, light from a different spectral range is superimposed on the beam 15 for the absorption measurement and is fed into the individual measurement cells 14 to supply energy. The figure shows the different components of the beam 15 separately, IR light 15a for the PAS measurement and optical radiation 15b in the range from 300 to 1100 nm for the power supply. The light beam of the optical radiation 15b is divided between the individual measurement cells 14 by means of suitable beam splitters 25. Part of the radiation is incident on a photodiode 24 in each measurement cell; the rest is forwarded to the next measurement cell. In the last measurement cell, a mirror can also be used, for example, instead of the beam splitter 25. The photodiode 24 then serves as a power source for the measurement cell or the detector used in the measurement cell for absorption measurement. It converts the incident optical radiation into corresponding electrical energy. Another electrical component that converts the absorbed optical radiation into corresponding electrical energy may also be used instead of a photodiode.

### LIST OF REFERENCE NUMERALS

12 Room
13 Light source(s)
14 Measurement cell(s)
15 Beams
15a IR light for PAS measurement
15b Optical radiation for power supply
16 Beam combiner
17 Mirror
18 Membrane
19 Detector unit
20 Measuring beam
21 Reflected measuring beam
22 Dichroic mirror
23 Optical system
24 Photodiode
25 Beam splitter

1. Assembly for detecting and/or determining the concentration of one or more substances in a liquid or gaseous medium which exhibit characteristic absorption peaks when illuminated with optical radiation, consisting of at least
a plurality of measurement cells distributed in the liquid or gaseous medium, each having
one or more detectors, by means of which an absorption of optical radiation in the liquid or gaseous medium can be sensed in the measurement cell for a plurality of the characteristic absorption peaks,
at least one entrance and one exit window for the optical radiation, and at least one inlet for the liquid or gaseous medium, and
an optical device for producing and guiding the optical radiation, by means of which a beam of the optical radiation is guided through all the measurement cells, and which comprises a plurality of light sources, each of which emits radiation at a wavelength of a different one of the characteristic absorption peaks, and a beam combiner, by means of which the radiation emitted by the light sources is merged to form the beam.

2. Assembly according to claim 1,
characterized in that
the light sources emit narrow-band radiation at the wavelength of the respective characteristic absorption peak.

3. Assembly according to claim 1,
characterized in that
the number of light sources is at least equal to the number of a selection from the characteristic absorption peaks that is required at minimum for determining the concentration of the one or more substances in the liquid or gaseous medium.

4. Assembly according to claim 1,
characterized in that
the measurement cells have an acoustic detector as detector.

5. Assembly according to claim 1,
characterized in that
the measurement cells each have at least one membrane as detector, wherein a membrane vibration of the membrane is read out via an optical measuring beam guided to the respective measurement cell.

6. Assembly according to claim 1,
characterized in that
the measurement cells are arranged in a room that is filled by the liquid or gaseous medium.

7. Assembly according to claim 1,
characterized in that
several of the measurement cells are arranged on a straight line along which the beam is guided through said measurement cells.

8. Assembly according to claim 1,
characterized in that
the optical device for generating and guiding the optical radiation includes one or more mirrors for guiding the beam.

9. Assembly according to claim 1,
characterized in that
the light sources are formed by narrow-band light emitters or by broadband light emitters with upstream optical filter(s).

10. Assembly according to claim 1,
characterized in that
the measurement cells are supplied with energy in a contactless manner via an optical beam.

11. Assembly according to claim 1,
characterized in that
the measurement cells have a gas-selective membrane at the inlet for the gaseous medium.

12. Method for detecting and/or determining the concentration of one or more substances in a liquid or gaseous medium which exhibit characteristic absorption peaks when illuminated with optical radiation, with an assembly according to claim 1, in which
a plurality of the measurement cells are distributed in the liquid or gaseous medium,
the optical device for generating and guiding the optical radiation is selected such that it has a number of light sources which is at least equal to the number of a selection from the characteristic absorption peaks that is required at minimum for determining the concentration of the one or more substances in the liquid or gaseous medium, wherein each of said light sources emits radiation, preferably narrow-band radiation, at a wavelength of a different characteristic absorption peak of the selection, and
the absorption at the characteristic absorption peaks of the selection is measured with the measurement cells.

13. Method according to claim 12,
characterized in that
the measurement is carried out using the measuring principle of photoacoustic spectroscopy.

14. Method according to claim 12,
characterized in that
the measurement is carried out with the individual light sources in temporal sequence.
